(19) United States
(12) Patent Application Publication
(10) Pub. No.: US 2017/0243386 A1
(43) Pub. Date: Aug. 24, 2017

(54) IMAGE PROCESSING APPARATUS, IMAGING APPARATUS, MICROSCOPE SYSTEM, IMAGE PROCESSING METHOD, AND COMPUTER-READABLE RECORDING MEDIUM

(71) Applicant: OLYMPUS CORPORATION, Tokyo (JP)

(72) Inventor: Shunichi KOGA, Tokyo (JP)

(73) Assignee: OLYMPUS CORPORATION, Tokyo (JP)

(21) Appl. No.: 15/587,450

(22) Filed: May 5, 2017

Related U.S. Application Data
(63) Continuation of application No. PCT/JP2014/080781, filed on Nov. 20, 2014.

(51) Int. Cl. G06T 11/60; G06T 5/00; G02B 21/36; G06T 7/70

(52) U.S. Cl. CPC G06T 11/60; G06T 7/70; G06T 5/008; G02B 21/367; G06T 2207/10016

(57) ABSTRACT

An image processing apparatus includes: an image acquisition unit configured to acquire a plurality of images of different fields of view, each of the plurality of images having a common area to share a common object with at least one other image of the plurality of images; a positional relation acquisition unit configured to acquire a positional relation between the plurality of images; an image composition unit configured to stitch the plurality of images based on the positional relation to generate a composite image; a shading component acquisition unit configured to acquire a shading component in each of the plurality of images; a correction gain calculation unit configured to calculate a correction gain based on the shading component and the positional relation; and an image correction unit configured to perform the shading correction on the composite image using the correction gain.

### CROSS-REFERENCE TO RELATED APPLICATIONS

This application is a continuation of International Application No. PCT/JP2014/080781 filed on Nov. 20, 2014, the entire contents of which are incorporated herein by reference.

### BACKGROUND

1. Technical Field

The disclosure relates to an image processing apparatus, an imaging apparatus, a microscope system, an image processing method, and a computer-readable recording medium for performing image processing on images acquired by imaging an object.

2. Related Art

In recent years, such a microscope system has been known that an image of a specimen placed on a glass slide in a microscope is recorded as electronic data, and the image is displayed on a monitor so as to be observed by a user. A virtual slide technique is used in the microscope system. Specifically, images of parts of the specimen magnified by the microscope are sequentially stitched together, whereby a high-resolution image in which the entire specimen is shown is constructed. In other words, the virtual slide technique is a technique for acquiring a plurality of images of different fields of view for the same object and connecting these images to generate an image of the magnified field of view for the object. A composite image generated by connecting the plurality of images is called a virtual slide image.

The microscope includes a light source for illuminating the specimen and an optical system for magnifying an image of the specimen. At an output stage of the optical system, an imaging sensor for converting the magnified image of the specimen into electronic data is provided. This structure may cause such a situation that an uneven brightness distribution occurs in the acquired image due to, for example, an uneven illuminance distribution of the light source, non-uniformity of the optical system, and a difference in characteristics of respective pixels of the imaging sensor. The uneven brightness distribution is called shading, which generally varies to become darkened as a position on the image is remote from the center of the image corresponding to a position of an optical axis of the optical system. Therefore, in a case where the virtual slide image is produced by stitching the plurality of images, an artificial boundary appears at a seam between the images. Since the shading is repeated as the plurality of images is stitched together, the image looks as if a periodic pattern existed on the specimen.

In order to address such a situation, JP 2013-257422 A discloses a technique for capturing a reference view field image that is an image in a predetermined view field range for a sample, moving a position of the sample relative to an optical system, capturing a plurality of peripheral view field images that is images in peripheral view field ranges including a predetermined area in the predetermined view field range but different from the predetermined view field range, calculating a correction gain of each pixel of the reference view field image based on the reference view field image and the peripheral view field images, and performing a shading correction.

JP 2011-124837 A discloses a technique for recording an image formed in an image circle that is an area corresponding to a field of view of an imaging optical system while shifting an imaging sensor relative to the imaging optical system, thereby acquiring a plurality of images having a smaller area than the image circle, positioning each image with the use of shift information of each image, and acquiring a composite image of these images.

### SUMMARY

In some embodiments, an image processing apparatus includes: an image acquisition unit configured to acquire a plurality of images of different fields of view, each of the plurality of images having a common area to share a common object with at least one other image of the plurality of images; a positional relation acquisition unit configured to acquire a positional relation between the plurality of images; an image composition unit configured to stitch the plurality of images based on the positional relation to generate a composite image; a shading component acquisition unit configured to acquire a shading component in each of the plurality of images; a correction gain calculation unit configured to calculate a correction gain that is used for a shading correction of the composite image, based on the shading component and the positional relation; and an image correction unit configured to perform the shading correction on the composite image using the correction gain.

In some embodiments, an imaging apparatus includes the image processing apparatus, and an imaging unit configured to image the object and output an image signal.

In some embodiments, a microscope system includes the image processing apparatus, an imaging unit configured to image the object and output an image signal, a stage on which the object is configured to be placed, and a drive unit configured to move at least one of the imaging unit and the stage relative to the other.

In some embodiments, an image processing method includes: acquiring a plurality of images of different fields of view, each of the plurality of images having a common area to share a common object with at least one other image of the plurality of images; acquiring a positional relation between the plurality of images; stitching the plurality of images based on the positional relation to generate a composite image; acquiring a shading component in each of the plurality of images; calculating a correction gain that is used for a shading correction of the composite image, based on the shading component and the positional relation; and performing the shading correction on the composite image using the correction gain.

In some embodiments, provided is a non-transitory computer-readable recording medium with an executable image processing program stored thereon. The image processing program causes a computer to execute: acquiring a plurality of images of different fields of view, each of the plurality of images having a common area to share a common object with at least one other image of the plurality of images; acquiring a positional relation between the plurality of images; stitching the plurality of images based on the positional relation to generate a composite image; acquiring a shading component in each of the plurality of images; calculating a correction gain that is used for a shading correction of the composite image, based on the shading component and the positional relation; and performing the shading correction on the composite image using the correction gain.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary configuration of an image processing apparatus according to a first embodiment of the present invention;

FIG. 2 is a schematic diagram for explaining the operation of an image acquisition unit illustrated in FIG. 1;

FIG. 3 is a flowchart illustrating the operation of the image processing apparatus illustrated in FIG. 1;

FIGS. 4A and 4B are schematic diagrams for explaining the operation of the image processing apparatus illustrated in FIG. 1;

FIGS. 5A and 5B are schematic diagrams for explaining a stitching process for images;

FIG. 6 is a schematic diagram illustrating a plurality of images acquired by sequentially capturing an object illustrated in FIGS. 4A and 4B;

FIG. 7 is a schematic diagram illustrating a composite image generated by stitching the plurality of images illustrated in FIG. 6;

FIG. 8 is a schematic diagram illustrating an example of a shading component in each image;

FIG. 9 is a schematic diagram for explaining a method of calculating a shading component in the composite image;

FIG. 10 is a schematic diagram for explaining the method of calculating the shading component in the composite image;

FIG. 11 is a schematic diagram illustrating the shading component in the composite image;

FIG. 12 is a schematic diagram illustrating a correction gain that is applied to the composite image;

FIG. 13 is a schematic diagram for explaining a shading correction for the composite image;

FIG. 14 is a block diagram illustrating a configuration of a shading component acquisition unit provided in an image processing apparatus according to a second embodiment of the present invention;

FIG. 15 is a schematic diagram for explaining a method of acquiring a shading component in each image;

FIG. 16 is a schematic diagram for explaining a method of capturing images that are used for acquiring the shading component in each image;

FIG. 17 is a schematic diagram illustrating a horizontal direction shading component;

FIG. 18 is a schematic diagram illustrating a vertical direction shading component;

FIG. 19 is a schematic diagram illustrating the shading component in each image;

FIGS. 20A and 20B are schematic diagrams for explaining a method of calculating the shading component in a block where only a denormalized shading component has been obtained;

FIGS. 21A and 21B are schematic diagrams for explaining another method of calculating the shading component in the block where only the denormalized shading component has been obtained;

FIG. 22 is a flowchart illustrating the operation of the image processing apparatus according to the second embodiment;

FIG. 23 is a schematic diagram for explaining a method of acquiring a shading component in a third embodiment of the present invention;

FIG. 24 is a schematic diagram for explaining the method of acquiring the shading component in the third embodiment of the present invention;

FIG. 25 is a schematic diagram illustrating an exemplary configuration of a microscope system according to a fourth embodiment of the present invention; and

FIG. 26 is a schematic diagram illustrating an exemplary screen on a display unit illustrated in FIG. 25.

### DETAILED DESCRIPTION

Exemplary embodiments of an image processing apparatus, an imaging apparatus, a microscope system, an image processing method, and an image processing program will be described in detail with reference to the drawings. The present invention is not limited by the embodiments. The same reference signs are used to designate the same elements throughout the drawings.

### First Embodiment

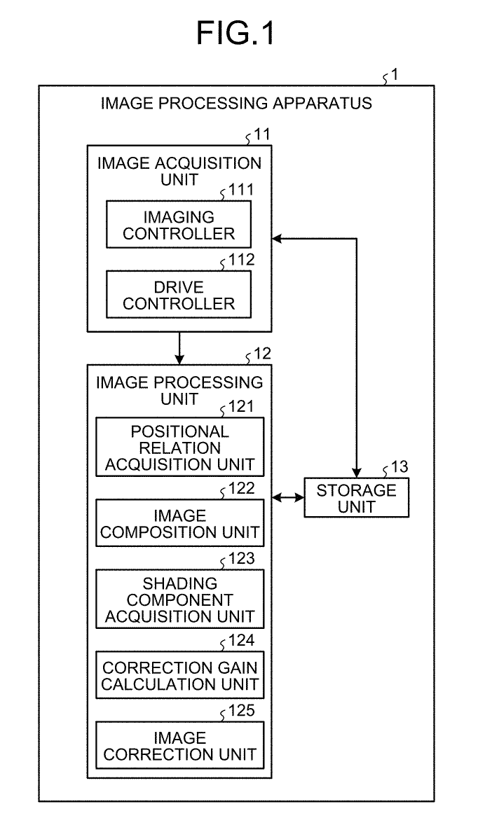

FIG. 1 is a block diagram illustrating an exemplary configuration of an image processing apparatus according to a first embodiment of the present invention. As illustrated in FIG. 1, an image processing apparatus 1 according to the first embodiment includes an image acquisition unit 11 for acquiring images in which an observation object is shown, an image processing unit 12 for performing image processing on the images, and a storage unit 13.

The image acquisition unit 11 acquires a plurality of images of different fields of view. Each of the plurality of images has a common area to share a common object with at least one other image. The image acquisition unit 11 may acquire the plurality of images directly from an imaging apparatus, or may acquire the plurality of images via a network, a storage device or the like. In the first embodiment, the image acquisition unit 11 is configured to acquire the images directly from the imaging apparatus. The type of imaging apparatus is not particularly limited. For example, the imaging apparatus may be a microscope device including an imaging function or may be a digital camera.

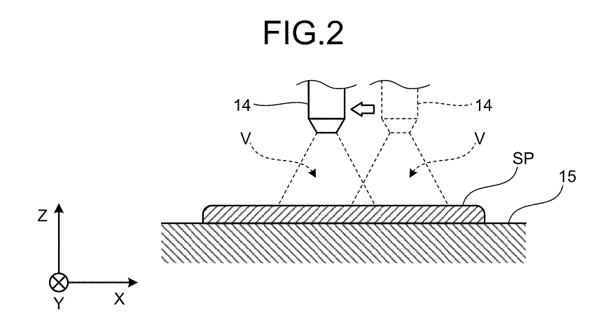

FIG. 2 is a schematic diagram for explaining the operation of the image acquisition unit 11 and illustrating an imaging optical system 14 provided at the imaging apparatus, a stage 15 on which an object SP is placed, and a field of view V of the imaging optical system 14. In FIG. 2, a placement surface of the stage 15 is assumed to be an XY plane, and an optical axis of the imaging optical system 14 is assumed to be a Z direction. At least one of the imaging optical system 14 and the stage 15 is provided with a drive unit (not illustrated) that varies a position on the XY plane.

The image acquisition unit 11 includes an imaging controller 111 and a drive controller 112. The imaging controller 111 controls the imaging operation in the imaging apparatus. The drive controller 112 controls the operation of the drive unit to vary a relative position between the imaging optical system 14 and the stage 15.

The drive controller 112 moves the relative position on the XY plane between the imaging optical system 14 and the stage 15 to sequentially move the field of view V with respect to the object SP. The imaging controller 111 executes the imaging control for the imaging apparatus in conjunction with the drive control by the drive controller 112, and retrieves, from the imaging apparatus, an image in which the object SP within the field of view V is shown. At this time, the drive controller 112 moves the imaging optical system 14 or the stage 15 so that the field of view V sequentially moves to overlap a part of the field of view V captured before.

In moving the relative position between the imaging optical system 14 and the stage 15, the stage 15 may be moved while the position of the imaging optical system 14 is fixed, or the imaging optical system 14 may be moved while the position of the stage 15 is fixed. Alternatively, both the imaging optical system 14 and the stage 15 may be moved relative to each other. With regard to a method of controlling the drive unit, a motor and an encoder that detects the amount of rotation of the motor may constitute the drive unit, and an output value of the encoder may be input to the drive controller 112, whereby the operation of the motor may be subjected to feedback control. Alternatively, a pulse generation unit that generates a pulse under the control of the drive controller 112 and a stepping motor may constitute the drive unit.

Referring again to FIG. 1, the image processing unit 12 stitches the plurality of images acquired by the image acquisition unit 11 to generate a composite image. Specifically, the image processing unit 12 includes a positional relation acquisition unit 121, an image composition unit 122, a shading component acquisition unit 123, a correction gain calculation unit 124, and an image correction unit 125. The positional relation acquisition unit 121 acquires a position relation between the plurality of images. The image composition unit 122 performs a stitching process to stitch the plurality of images and generate the composite image. The shading component acquisition unit 123 acquires a shading component generated in each image corresponding to the field of view V of the imaging optical system 14. The correction gain calculation unit 124 calculates a correction gain that is used for a shading correction for the composite image based on the shading component and the positional relation between the plurality of images. The image correction unit 125 performs the shading correction on the composite image using the correction gain.

The positional relation acquisition unit 121 acquires, from the drive controller 112, control information for the drive unit provided at the imaging optical system 14 or the stage 15, and acquires the positional relation between the images from the control information. More specifically, the positional relation acquisition unit 121 may acquire, as the positional relation, the center coordinates of the field of view (or upper left coordinates of the field of view) for each of the captured images, or the amount of movement by which the field of view is moved each time the image is captured. Alternatively, a motion vector between the images acquired in series may be acquired as the positional relation.

The image composition unit 122 stitches the plurality of images acquired by the image acquisition unit 11 based on the positional relation acquired by the positional relation acquisition unit 121 to generate the composite image.

The shading component acquisition unit 123 acquires the shading component generated in the image by capturing the field of view V using the imaging optical system 14. In the first embodiment, the shading component acquisition unit 123 is configured to hold the shading component acquired in advance. The shading component can be obtained from an image captured when a white plate or a glass slide on which a specimen is not fixed is placed on the stage 15 instead of the object SP. Alternatively, the shading component may be calculated in advance based on design data for the imaging optical system 14.

The correction gain calculation unit 124 calculates the correction gain that is applied to the composite image generated by the image composition unit 122 based on the shading component acquired by the shading component acquisition unit 123 and the positional relation between the plurality of images acquired by the positional relation acquisition unit 121.

The image correction unit 125 corrects the shading occurred in the composite image using the correction gain calculated by the correction gain calculation unit 124.

The storage unit 13 includes a storage device such as a semiconductor memory, e.g., a flash memory capable of updating a record, a RAM, and a ROM. The storage unit 13 stores, for example, various types of parameters that are used by the image acquisition unit 11 for controlling the imaging apparatus, image data of the composite image generated by the image processing unit 12, and various types of parameters that are used in the image processing unit 12.

The image acquisition unit 11 and the image processing unit 12 mentioned above may be realized by use of dedicated hardware, or may be realized by reading predetermined programs into a CPU. In the latter case, image processing programs for causing the image acquisition unit 11 and the image processing unit 12 to execute a predetermined process may be stored in the storage unit 13, and various types of parameters and setting information that are used during the execution of the programs may be stored in the storage unit 13. Alternatively, the above-mentioned image processing programs and parameters may be stored in a storage device coupled to the image processing apparatus 1 via a data communication terminal. The storage device may include, for example, a recording medium such as a hard disk, an MO disc, a CD-R disc, and a DVD-R disc, and a writing/reading device that writes and reads information to and from the recording medium.

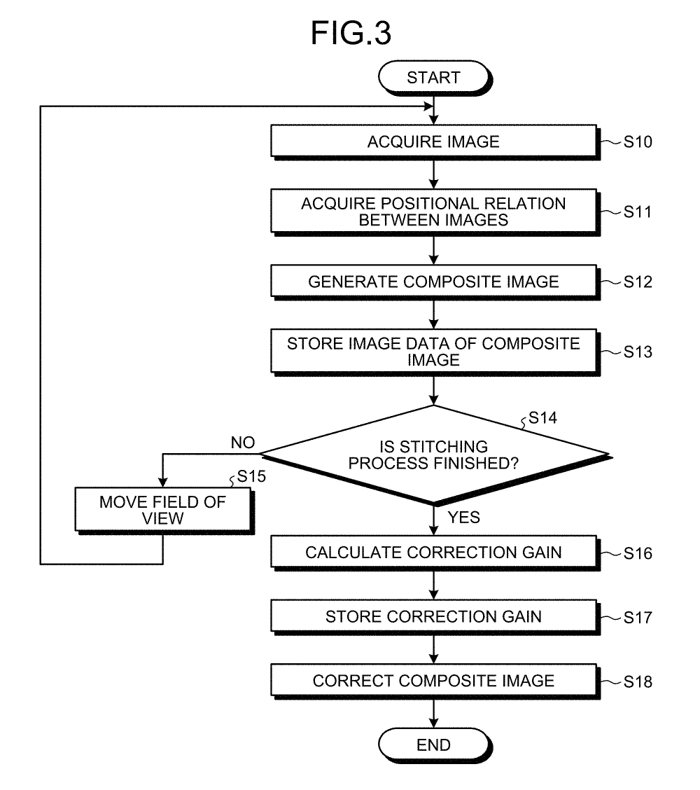

Next, the operation of the image processing apparatus 1 will be described with reference to FIGS. 3 to 13. FIG. 3 is a flowchart illustrating the operation of the image processing apparatus 1. As mentioned above, the first embodiment is based on the premise that the shading component acquisition unit 123 acquires and holds the shading component in advance.

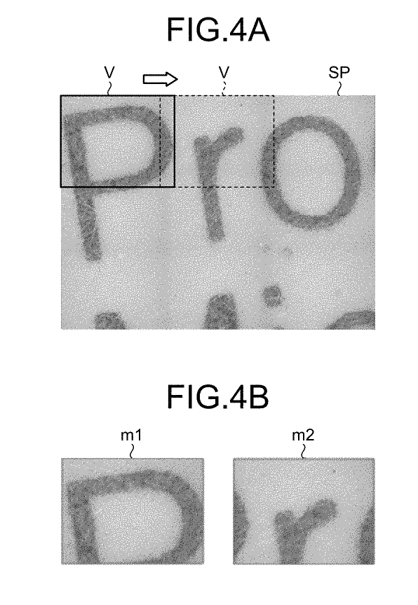

First, in step S10, the image acquisition unit 11 acquires an image in which a part of the object is shown. FIGS. 4A and 4B are schematic diagrams for explaining a method of capturing the object. The following description is based on the assumption that images are captured multiple times while the field of view V is moved with respect to the object SP illustrated in FIG. 4A, whereby images m1, m2, etc. in which parts of the object SP are shown are sequentially acquired. A moving direction of the field of view V with respect to the object SP and capturing order for areas on the object SP are not particularly limited. Only when the image acquisition unit 11 first executes step S10, the image acquisition unit 11 captures the images two times so that parts of the fields of view V overlap each other, whereby the two images m1 and m2 are acquired (refer to FIG. 4B).

In subsequent step S11, the positional relation acquisition unit 121 acquires the positional relation between the latest image (image m2 in the case of FIG. 4B) and the image acquired before (image m1 in the case of FIG. 4B). The positional relation can be acquired from, for example, the amount of movement of the stage on which the object SP is placed (value of a scale), the driving amount of the drive unit provided at the stage, the number of pulses of the stepping motor, a result of a matching process for the images m1 and m2, the motion vector of the object shown in the images m1 and m2, and a combination thereof. The positional relation acquisition unit 121 causes the storage unit 13 to store information representing the acquired positional relation.

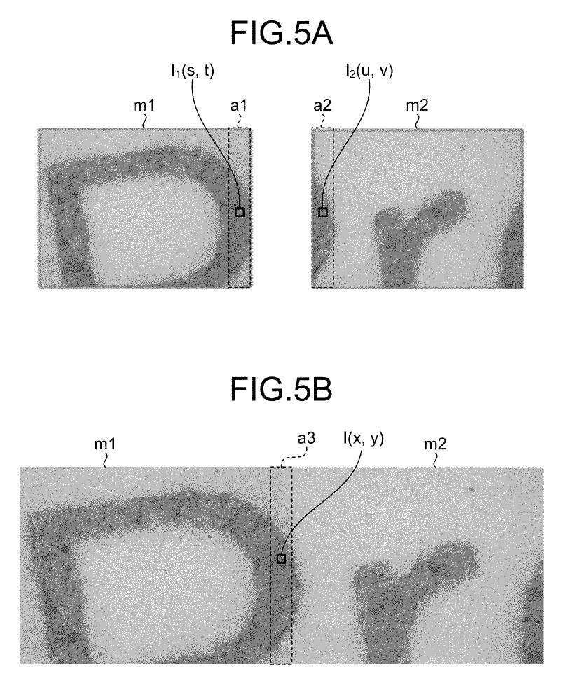

In subsequent step S12, the image composition unit 122 generates a composite image by stitching the latest image and the image acquired before based on the positional relation between the images acquired in step S11. FIGS. 5A and 5B are schematic diagrams for explaining the stitching process for the images.

For example, in a case where the image m1 acquired before and the latest image m2 are stitched together as illustrated in FIG. 5A, the image composition unit 122 extracts common areas a1 and a2 between the image m1 and the image m2 based on the positional relation between the image m1 and the image m2, and performs the composition by causing the common areas a1 and a2 to overlap each other. More specifically, as illustrated in FIG. 5B, the luminance I (x, y) of a pixel at coordinates (x, y) in an area a3 where the common areas a1 and a2 overlap each other is obtained by weighting and adding the luminance I₁ (s, t) and luminance I₂ (u, v) of pixels at the corresponding positions in the common areas a1 and a2. As used herein, the luminance I₁ (s, t) is the luminance of the pixel at the coordinates (s, t) in the image m1 corresponding to the coordinates (x, y) in the area a3, and the luminance I₂ (u, v) is the luminance of the pixel at the coordinates (u, v) in the image m2 corresponding to the same coordinates (x, y). The luminance I (x, y) in the area a3 within the composite image is given by the following Expression (1).

I(x,y)=α×I₁(s,t)+(1−α)×I₂(u,v) (1)

As given by Expression (1), the composition method for weighting and adding that the sum of weight coefficients is equal to 1 is called α-blending, and the weight coefficient α of Expression (1) is also called a blending coefficient. The blending coefficient α may be a preset fixed value. For example, when α=0.5 is satisfied, the luminance I (x, y) is a simple average of the luminance I₁ (s, t) and the luminance I₂ (u, v). When α=1 or α=0 is satisfied, either the luminance I₁ (s, t) or the luminance I₂ (u, v) is employed as the luminance I (x, y).

The blending coefficient α may be varied in accordance with the coordinates of the pixel to be blended. For example, the blending coefficient α may be set to 0.5 when the coordinate x in a horizontal direction (right-left direction in the drawings) is located in the center of the area a3. The blending coefficient α may be close to 1 as the coordinate x is close to the center of the image m1, and the blending coefficient α may be close to 0 as the coordinate x is close to the center of the image m2.

Alternatively, the blending coefficient α may be varied so as to adapt to the luminance of the pixel to be blended or a value that is calculated from the luminance. A specific example thereof includes a method of employing the greater value of the luminance I₁ (s, t) and the luminance I₂ (u, v) as the luminance I (x, y) (in other words, α=1 is employed when I₁ (s, t)≧I₂ (u, v) is satisfied, and α=0 is employed when I₁ (s, t)≦I₂ (u, v) is satisfied).

In step S13, the image composition unit 122 causes the storage unit 13 to store image data of the composite image after the stitching process. At this time, the unstitched original images m1, m2, etc. may be sequentially erased after the stitching process. In addition, in a case where the blending coefficient α has been varied, the image composition unit 122 causes the storage unit 13 to store the blending coefficient α for each pixel in the area a3.

In subsequent step S14, the image processing apparatus 1 determines whether the stitching process is finished. For example, if image capture has been performed on all the areas of the object SP illustrated in FIG. 4A, the image processing apparatus 1 determines to finish the stitching process (step S14: Yes), and proceeds to subsequent step S16.

On the other hand, if there is still some area of the object SP on which the image capture has not been performed, the image processing apparatus 1 determines not to finish the stitching process (step S14: No), and moves the field of view V (step S15). At this time, the drive controller 112 performs the drive control for the imaging apparatus so that the moved field of view V overlaps a part of the captured field of view V. After that, the imaging controller 111 acquires an image by causing the imaging apparatus to capture the moved field of view V (step S10). Subsequent steps S11 to S15 are the same as those described above. Among them, in step S13, the image data of the composite image stored in the storage unit 13 are updated each time a new composite image is generated.

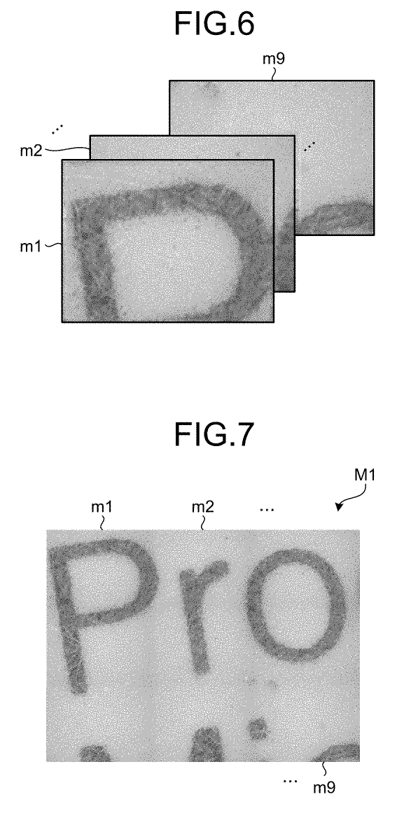

FIG. 6 is a schematic diagram illustrating images m1 to m9 acquired by sequentially capturing the object SP. FIG. 7 is a schematic diagram illustrating a composite image generated by stitching the images m1 to m9. Steps S10 to S15 mentioned above are repeated, and newly acquired images and the images acquired before are sequentially stitched together, whereby the composite image M1 illustrated in FIG. 7 is generated. As illustrated in FIG. 7, since the images m1 to m9 are stitched together to form the composite image M1 without undergoing the shading correction, grid-like shading occurs over the entire composite image M1.

In step S16, the correction gain calculation unit 124 calculates a correction gain that is applied to the composite image M1. Specifically, the correction gain calculation unit 124 retrieves a shading component in each of the images m1 to m9 from the shading component acquisition unit 123, and retrieves the information of the positional relation between the images acquired in step S11 from the storage unit 13. Based on these items of information, the correction gain calculation unit 124 calculates a shading component in the composite image M1, and calculates the correction gain from the shading component.

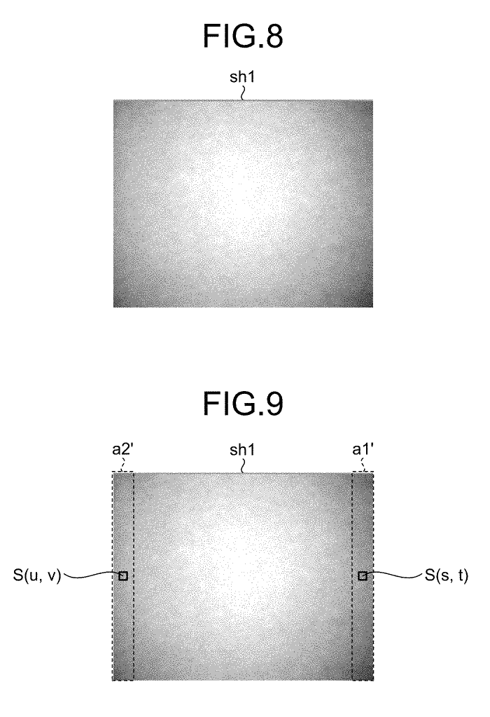

FIG. 8 is a schematic diagram illustrating an example of the shading component in each image. A shading component sh1 illustrated in FIG. 8 has such characteristics that the brightness is high in the central part of the image, and the brightness is lowered as a position on the image is apart from the central part of the image.

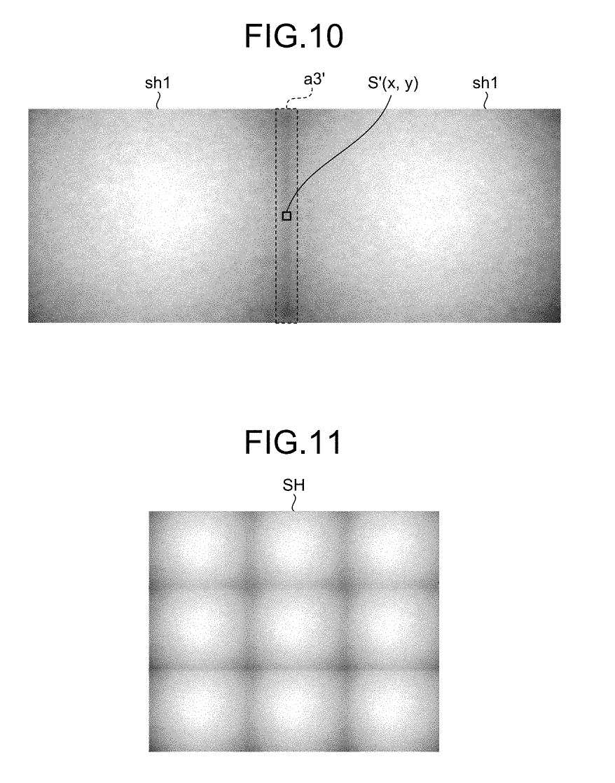

FIGS. 9 and 10 are schematic diagrams for explaining a method of calculating the shading component in the composite image M1. For example, in a case where the shading component in the area a3 (refer to FIGS. 5A and 5B) where the common areas a1 and a2 of the images m1 and m2 overlap each other is calculated, the correction gain calculation unit 124 first extracts shading components of areas a1′ and a2′ corresponding to the common areas a1 and a2 from the shading component sh1 as illustrated in FIG. 9. Then, as illustrated in FIG. 10, the shading component sh1 is replicated so that the areas a1′ and a2′ overlap each other, whereby the composition is performed. A shading component S′ (x, y) of a pixel at coordinate (x, y) in an area a3′ where the areas a1′ and a2′ overlap each other is provided by performing the α-blending on the shading components S (s, t) and S (u, v) of the corresponding pixels between the areas a1′ and a2′ as represented by the following Expression (2).

S(x,y)=α×S(s,t)+(1−α)×S(u,v) (2)

In a case where the blending coefficient α has been varied in the stitching process of the images, the blending coefficient α used at that time is acquired from the storage unit 13, and the composition of the shading component sh1 is performed using the same blending coefficient α as for the stitching process.

The composition of the shading component sh1 is performed based on the positional relation between the images m1 to m9, whereby a shading component SH in the composite image M1 can be obtained as illustrated in FIG. 11.

The correction gain calculation unit 124 further calculates a reciprocal of the shading component SH as represented by the following Expression (3), thereby obtaining a correction gain G (x, y) that is used for the shading correction for the composite image M1.

$$G ( x , y ) = \frac{1}{S ( x , y )} \qquad ( 3 )$$

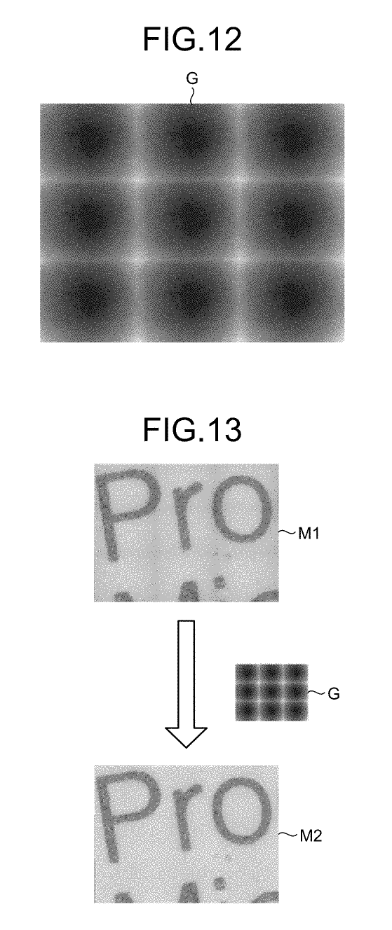

FIG. 12 is a schematic diagram illustrating the correction gain G calculated in the above-mentioned manner.

In subsequent step S17, the correction gain calculation unit 124 causes the storage unit 13 to store the calculated correction gain G.

In subsequent step S18, the image correction unit 125 performs the shading correction for the composite image M1 using the correction gain G calculated in step S16. FIG. 13 is a schematic diagram for explaining the shading correction for the composite image M1.

A texture component T (x, y) that is a luminance value after the shading correction in a composite image M2 is given by the following Expression (4).

T(x,y)=I(x,y)×G(x,y) (4)

Here, reference will be made to the principle to correct the shading in the area (for example, area a3 illustrated in FIG. 5B) where the common areas overlap each other, using the correction gain G. As represented by Expression (1), the luminance I (x, y) of the pixel in the area a3 of the composite image is calculated by performing the α-blending on the luminance I₁ (s, t) and luminance I₂ (u, v) of the corresponding pixels between the common areas a1 and a2 within the images m1 and m2.

Since the luminance I₁ (s, t) in Expression (1) is actually composed of a texture component T₁ (s, t) and the shading component S (s, t), the luminance I₁ (s, t) can be represented as I₁ (s, t)=T₁ (s, t)×S (s, t). Similarly, using a texture component T₂ (u, v) and the shading component S (u, v), the luminance I₂ (u, v) can be represented as I₂ (u, v)=I₂ (u, v)×S (u, v). They are assigned to Expression (1), whereby the following Expression (5) is obtained.

I(x,y)=α×T₁(s,t)×S(s,t)+(1−α)×T₂(u,v)×S(u,v) (5)

Since the texture component T₁ (s, t) and the texture component T₂ (u, v) in Expression (5) are equivalent to the texture component T (x, y) in the area a3 of the composite image, the following Expression (6) is obtained by assigning T₁ (s, t)=T₂ (u, v)=T (x, y) to Expression (5).

$$T ( x , y ) = \frac{I ( x , y )}{α \times S ( s , t ) + ( 1 - α ) \times S ( u , v )} \qquad ( 6 )$$

Thus, the texture component T (x, y) after the removal of the shading component can be obtained in the area a3 as well.

After that, the image processing apparatus 1 finishes the process.

As described above, according to the first embodiment of the present invention, the stitching process is performed each time the object SP is sequentially captured to acquire the images m1, m2, etc., and the shading correction is performed on the composite image eventually obtained. Therefore, the shading correction for the individual images can be omitted, and the throughput of the stitching process can be improved.

In addition, according to the first embodiment of the present invention, the shading correction is performed after the composite image M1 is generated. Therefore, the shading correction can be freely performed as compared with the conventional shading correction. For example, the shading correction alone can be performed again after a failure of the shading correction.

In addition, according to the first embodiment of the present invention, the composite image M1 before the shading correction and the correction gain G that is used for the shading correction for the composite image are stored in the storage unit 13. Therefore, both the composite image before the shading correction and the composite image after the shading correction can be appropriately generated. Alternatively, the correction gain G may be generated and deleted each time the shading correction is performed in order to save the memory capacity of the storage unit 13.

Furthermore, according to the first embodiment, the memory capacity of the storage unit 13 can be saved since the original images m1, m2, etc. are erased after the stitching process.

### Second Embodiment

Next, a second embodiment of the present invention will be described.

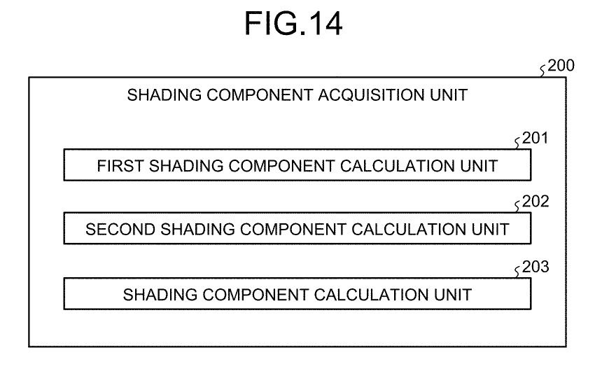

FIG. 14 is a block diagram illustrating a configuration of a shading component acquisition unit provided in an image processing apparatus according to the second embodiment of the present invention. The image processing apparatus according to the second embodiment includes a shading component acquisition unit 200 illustrated in FIG. 14 in place of the shading component acquisition unit 123 illustrated in FIG. 1. A configuration of each component of the image processing apparatus other than the shading component acquisition unit 200 is similar to that of the first embodiment.

The shading component acquisition unit 200 acquires a shading component in each image corresponding to the field of view V (refer to FIG. 2) using images acquired by the image acquisition unit 11. Specifically, the shading component acquisition unit 200 includes a first shading component calculation unit 201, a second shading component calculation unit 202, and a shading component calculation unit (third shading component calculation unit) 203. The first shading component calculation unit 201 calculates characteristics of a shading component in the horizontal direction (right-left direction in the drawings) among the shading components. The second shading component calculation unit 202 calculates characteristics of a shading component in a vertical direction (up-down direction in the drawings). The shading component calculation unit 203 calculates a shading component of the entire image using the characteristics of the shading components in the horizontal direction and the vertical direction.

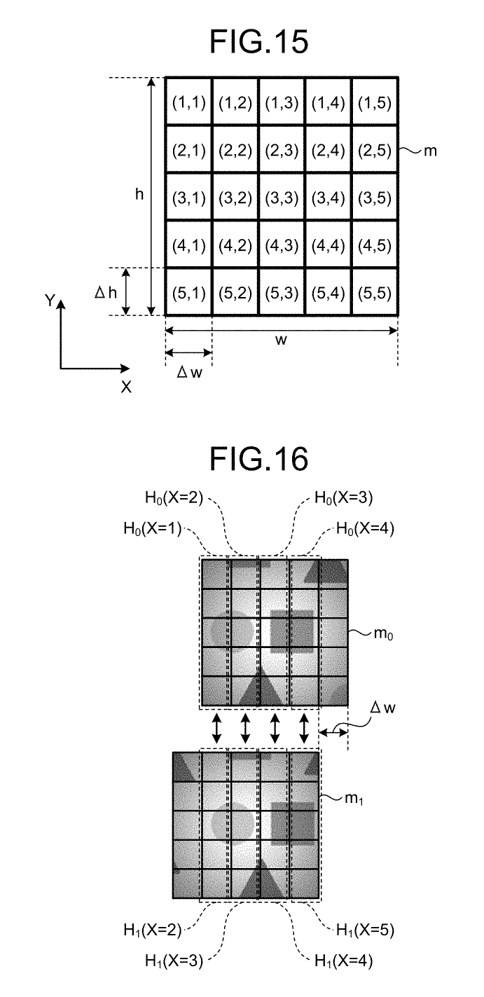

Hereinafter, a method of acquiring the shading component by the shading component acquisition unit 200 will be described in detail. FIGS. 15 to 21B are schematic diagrams for explaining the method of acquiring the shading component in the second embodiment. As illustrated in FIG. 15, a single image m having a length w in the horizontal direction (right-left direction in the drawings) and a length h in the vertical direction (up-down direction in the drawings) is segmented into a predetermined number of blocks (for example, 5×5=25 blocks), and a position of each block is hereinafter represented by (X, Y). In the case of FIG. 15, (X, Y)=(1, 1) to (5, 5) is satisfied. The length of each block in the horizontal direction is denoted by Δw, and the length in the vertical direction is denoted by Δh.

As illustrated in FIG. 8, generally, the central part of the image has an area where the shading hardly occurs (in other words, the shading component is 1.0) and does not even vary. Hereinafter, such an area is referred to as a flat area. The shading component varies in a substantially concentric pattern from the flat area to the end of the image. In this regard, in the second embodiment, the central block (3, 3) is regarded as the flat area among the blocks (1, 1) to (5, 5) of the segmented image m as illustrated in FIG. 15, and shading components of the other blocks are calculated.

FIG. 16 is a schematic diagram for explaining a method of capturing images that are used for acquiring the shading component. The following discussion is based on the assumption that, as illustrated in FIG. 16, an image is captured with the field of view V (refer to FIG. 2) focused on a certain area on the object SP, whereby an image m₀ is acquired, and another image is then captured with the field of view V shifted in the horizontal direction by a predetermined distance (for example, length Δw corresponding to a single block), whereby an image m₁ is acquired. In this case, a column X=1 of the image m₀ and a column X=2 of the image m₁ are common areas. The distance by which the field of view V is moved may be a distance by which a user freely moves the stage 15 (refer to FIG. 2) in the horizontal direction as well as a distance determined in advance. Alternatively, the shift amount between a pair of images selected from a group of images serially acquired while the stage 15 is moved in the horizontal direction can be employed as the length Δw per block. In these cases, the number of segmentation blocks in the horizontal direction is determined by dividing the length w of the image m in the horizontal direction by the shift amount (length Δw) between the images.

The luminance H₀ (X=1) of an arbitrary pixel included in the column X=1 of the image m₀ is composed of a texture component T₀ (X=1) and a shading component Sh (X=1) at the arbitrary pixel. In other words, H₀ (X=1)=T₀ (X=1)×Sh (X=1) is satisfied. The luminance of a pixel, which shares a common object with the arbitrary pixel and is included in the column X=2 of the image m₁, is denoted by H₁ (X=2). The luminance H₁ (X=2) is composed of a texture component T₁ (X=2) and a shading component Sh (X=2) at this pixel. In other words, H₁ (X=2)=T₂ (X=2)×Sh (X=2) is satisfied.

As mentioned above, since the column X=1 of the image m₀ and the column X=2 of the image m₁ are the common areas, the texture components T₀ (X=1) and T₁ (X=2) are equal to each other. Therefore, the following Expression (7-1) is satisfied.

$$\frac{{H}_{0} ( X = 1 )}{Sh ( X = 1 )} = \frac{{H}_{1} ( X = 2 )}{Sh ( X = 2 )} \\ Sh ( X = 1 ) = \frac{{H}_{0} ( X = 1 )}{{H}_{1} ( X = 2 )} \times Sh ( X = 2 ) \qquad ( 7 \text{-} 1 )$$

Similarly, by utilizing the fact that a column X=2 of the image m₀ and a column X=3 of the image m₁, a column X=3 of the image m₀ and a column X=4 of the image m₁, and a column X=4 of the image m₀ and a column X=5 of the image m₁ are common areas, Expressions (7-2) to (7-4) representing shading components Sh (X=2), Sh (X=3), and Sh (X=4) at arbitrary pixels included in the respective columns X=2, X=3, and X=4 are obtained.

$$\begin{matrix}Sh ( X = 2 ) = \frac{{H}_{0} ( X = 2 )}{{H}_{1} ( X = 3 )} \times Sh ( X = 3 ) & ( 7 \text{-} 2 ) \\ Sh ( X = 3 ) = \frac{{X}_{0} ( X = 3 )}{{X}_{1} ( X = 4 )} \times Sh ( X = 4 ) & ( 7 \text{-} 3 ) \\ Sh ( X = 4 ) = \frac{{H}_{0} ( X = 4 )}{{H}_{1} ( X = 5 )} \times Sh ( X = 5 ) & ( 7 \text{-} 4 )\end{matrix}$$

Then, suppose that the shading component Sh (X=3) at the pixel included in the central column X=3 including the flat area (3, 3) is a reference, Expressions (8-1) to (8-5) representing shading components Sh (X=1) to Sh (X=5) at arbitrary pixels included in the respective columns are obtained by assigning the shading component Sh (X=3)=1.0 to Expressions (7-1) to (7-4).

$$\begin{matrix}Sh ( X = 1 ) = \frac{{H}_{0} ( X = 1 )}{{H}_{1} ( X = 2 )} \times Sh ( X = 2 ) & ( 8 \text{-} 1 ) \\ Sh ( X = 2 ) = \frac{{H}_{0} ( X = 2 )}{{H}_{1} ( X = 3 )} & ( 8 \text{-} 2 ) \\ Sh ( X = 3 ) = 1.0 & ( 8 \text{-} 3 ) \\ Sh ( X = 4 ) = \frac{{H}_{1} ( X = 4 )}{{H}_{0} ( X = 3 )} & ( 8 \text{-} 4 ) \\ Sh ( X = 5 ) = \frac{{H}_{1} ( X = 5 )}{{H}_{0} ( X = 4 )} \times Sh ( X = 4 ) & ( 8 \text{-} 5 )\end{matrix}$$

As represented by Expression (8-2), the shading component Sh (X=2) is given by the luminance H₀ (X=2) and luminance H₁ (X=3). In addition, as represented by Expression (8-1), the shading component Sh (X=1) is given by the shading component Sh (X=2) calculated by Expression (8-2) and the luminance H₀ (X=1) and luminance H₁ (X=2). In addition, as represented by Expression (8-4), the shading component Sh (X=4) is given by the luminance H₀ (X=3) and luminance H₁ (X=4). Furthermore, as represented by Expression (8-5), the shading component Sh (X=5) is given by the shading component Sh (X=4) calculated by Expression (8-4) and the luminance H₀ (X=4) and luminance H₁ (X=5). In other words, as represented by Expressions (8-1) to (8-5), the shading component at the arbitrary pixel included in each column can be calculated using the luminance of the pixels in the images m₀ and m₁.

Specifically, if the shading component (Sh (X=3)) in a partial area (for example, column X=3) within the image is known (1.0 in the case of the flat area), an unknown shading component (Sh (X=4)) can be calculated using the ratio (H₁ (X=4)/H₀ (X=3)) between the luminance (H₀ (X=3)) of the pixel in the area (column X=3) having the known shading component in one image (for example, image m₀) and the luminance (H₁ (X=4)) of the pixel at the corresponding position in the area (X=4) in the other image (image m₁) which shares the common object with the area (column X=3), and using the known shading component (Sh (X=3)). The above-mentioned computation is sequentially repeated, whereby the shading component of the entire image can be acquired.

The first shading component calculation unit 201 performs the above-mentioned computation, thereby acquiring the shading components Sh (X=1) to Sh (X=5) (hereinafter also collectively referred to as a shading component Sh), and causing the storage unit 13 to store the shading components Sh (X=1) to Sh (X=5). Hereinafter, the shading component Sh acquired from the images m₀ and m₁ of the fields of view shifted in the horizontal direction is also referred to as a horizontal direction shading component Sh.

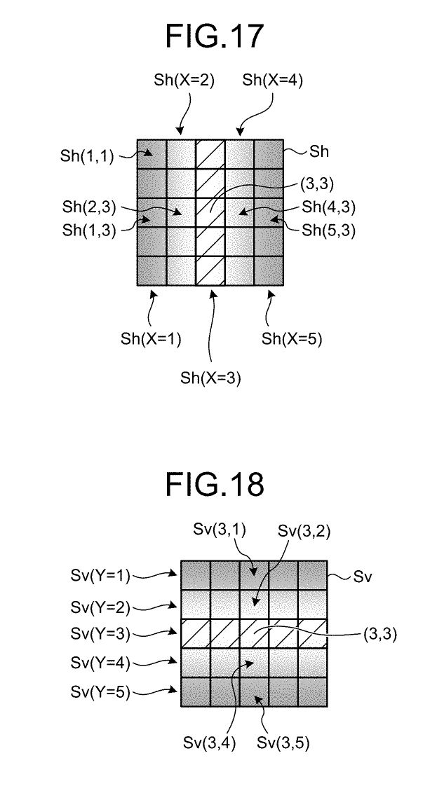

Although the first shading component calculation unit 201 may calculate the horizontal direction shading component Sh from the two images of the fields of view shifted in the horizontal direction, the first shading component calculation unit 201 may calculate a plurality of horizontal direction shading components Sh at the same pixel position from multiple pairs of images of the fields of view shifted in the horizontal direction, and average these horizontal direction shading components Sh to acquire a final horizontal direction shading component Sh. Consequently, a deterioration in the accuracy of the shading component caused by image degradation such as random noise, blown-out highlights, and blocked up shadows can be suppressed. FIG. 17 is a schematic diagram illustrating the horizontal direction shading component Sh acquired in this manner. In FIG. 17, the blocks of the shading component Sh (X=3) utilized as the reference are marked with diagonal lines.

The second shading component calculation unit 202 acquires a shading component from images of the fields of view shifted in the vertical direction. Specifically, the second shading component calculation unit 202 retrieves, from the image acquisition unit 11, an image captured and acquired with the field of view V focused on a certain area on the object SP and an image captured and acquired with the field of view V shifted in the vertical direction by a predetermined distance (for example, length Δh corresponding to a single block, refer to FIG. 15). The distance by which the field of view V is moved may be a distance by which the stage 15 (refer to FIG. 2) is freely moved in the vertical direction in a manner similar to that for the horizontal direction. Alternatively, the shift amount between a pair of images selected from a group of images serially acquired while the stage 15 is moved in the vertical direction can be employed as the length Δh per block. In these cases, the number of segmentation blocks in the vertical direction can be determined later in accordance with the length Δh per block. Then, a computation similar to the above-mentioned calculation of the horizontal direction shading component Sh is performed, whereby shading components at arbitrary pixels included in respective rows (Y=1, Y=2, Y=3, Y=4, and Y=5) are obtained and stored in the storage unit 13. Hereinafter, the shading components acquired from the two images of the fields of view shifted in the vertical direction are referred to as vertical direction shading components Sv (Y=1) to Sv (Y=5), which are also collectively referred to as a vertical direction shading component Sv.

In the same way as above, when the vertical direction shading component is acquired, a plurality of vertical direction shading components Sv at the same pixel position may be calculated from multiple pairs of images, and the vertical direction shading components Sv may be averaged for acquiring a final vertical direction shading component Sv. FIG. 18 is a schematic diagram illustrating the vertical direction shading component Sv. In FIG. 18, the blocks of the shading component Sv (Y=3) utilized as the reference are marked with diagonal lines.

The shading component calculation unit 203 calculates a shading component in each image using the horizontal direction shading component Sh calculated by the first shading component calculation unit 201 and the vertical direction shading component Sv calculated by the second shading component calculation unit 202. Hereinafter, a shading component at an arbitrary pixel in a block (X, Y) among the horizontal direction shading components Sh is denoted by Sh (X, Y). Similarly, a shading component at an arbitrary pixel in a block (X, Y) among the vertical direction shading components Sv is denoted by Sv (X, Y).

Among the horizontal direction shading components Sh (X=1), Sh (X=2), Sh (X=4), and Sh (X=5) illustrated in FIG. 17, the shading components Sh (1, 3), Sh (2, 3), Sh (4, 3), and Sh (5, 3) of the blocks in the third row are calculated using the shading component of the block (3, 3), namely, the flat area, as the reference (1.0). Therefore, among the horizontal direction shading components Sh, the shading components Sh (1, 3), Sh (2, 3), Sh (4, 3), and Sh (5, 3) of the blocks calculated using the shading component of the flat area (3, 3) as the reference are referred to as normalized shading components.

To the contrary, among the horizontal direction shading components Sh (X=1), Sh (X=2), Sh (X=4), and Sh (X=5), the shading components of the blocks in the first, second, fourth, and fifth rows are calculated while the shading components Sh (3, 1), Sh (3, 2), Sh (3, 4), and Sh (3, 5) of the blocks other than the flat area (3, 3) are regarded as the reference (1.0). Therefore, the shading components (such as Sh (1, 1)) calculated using the shading components of the blocks other than the flat area as the reference are referred to as denormalized shading components.

In addition, among the vertical direction shading components Sv (Y=1), Sv (Y=2), Sv (Y=4), and Sv (Y=5) illustrated in FIG. 18, the shading components Sv (3, 1), Sv (3, 2), Sv (3, 4), and Sv (3, 5) of the blocks in the third column are calculated using the shading component of the block (3, 3), namely, the flat area, as the reference (1.0). Therefore, among the vertical direction shading components Sv, the shading components Sv (3, 1), Sv (3, 2), Sv (3, 4), and Sv (3, 5) of the blocks calculated using the shading component of the flat area (3, 3) as the reference are referred to as the normalized shading components.

To the contrary, among the vertical direction shading components Sv (Y=1), Sv (Y=2), Sv (Y=4), and Sv (Y=5), the shading components of the blocks in the first, second, fourth, and fifth columns are calculated while the shading components Sv (1, 3), Sv (2, 3), Sv (4, 3), and Sv (5, 3) other than the flat area (3, 3) are regarded as the reference (1.0). Therefore, the shading components (such as Sv (1, 1)) of these blocks are referred to as the denormalized shading components.

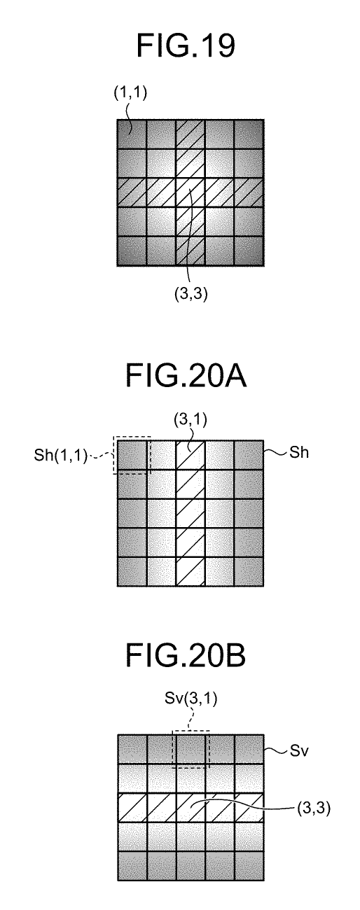

The shading component calculation unit 203 determines, as the shading components S (X, Y) of the respective blocks, the shading component 1.0 of the flat area (3, 3), the normalized shading components Sh (1, 3), Sh (2, 3), Sh (4, 3), and Sh (5, 3) among the horizontal direction shading components Sh, and the normalized shading components Sv (3, 1), Sv (3, 2), Sv (3, 4), and Sv (3, 5) among the vertical direction shading components Sv, and causes the storage unit 13 to store these shading components. FIG. 19 is a schematic diagram illustrating the shading component in each image. The flat area and the blocks where the normalized shading components are obtained are marked with diagonal lines.

The shading component calculation unit 203 also calculates the shading component of the block where only the denormalized shading component has been obtained by using the denormalized shading component of the block and the normalized shading component in the same row or column as the block. FIGS. 20A and 20B are schematic diagrams for explaining a method of calculating the shading component in the block where only the denormalized shading component has been obtained.

In the following discussion, for example, the shading component S (1, 1) of the block (1, 1) illustrated in FIG. 19 is calculated. As illustrated in FIG. 20A, the denormalized shading component Sh (1, 1) of the block (1, 1) is calculated while the shading component of the block (3, 1) in the same row is regarded as the reference (1.0). With regard to the block (3, 1), as illustrated in FIG. 20B, the normalized shading component Sv (3, 1) is calculated and obtained using the flat area (3, 3) as the reference. Therefore, the shading component S (1, 1) of the block (1, 1) is given by the following Expression (9).

S(1,1)=Sh(1,1)×Sv(3,1) (9)

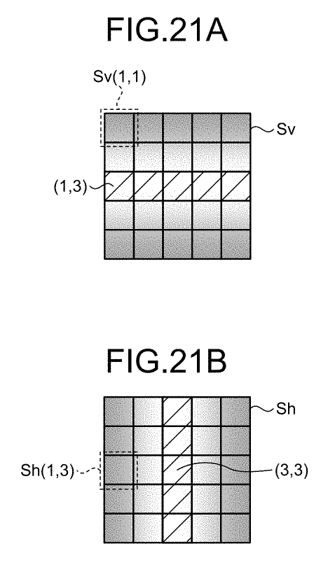

Alternatively, the shading component S (1, 1) of the same block (1, 1) can be obtained in the following manner. As illustrated in FIG. 21A, the denormalized shading component Sv (1, 1) of the block (1, 1) is calculated while the shading component of the block (1, 3) in the same column is regarded as the reference (1.0). With regard to the block (1, 3), as illustrated in FIG. 21B, the normalized shading component Sh (1, 3) is calculated and obtained using the flat area (3, 3) as the reference. Therefore, the shading component S (1, 1) of the block (1, 1) is given by the following Expression (10).

S(1,1)=Sv(1,1)×Sh(1,3) (10)

These calculation expressions are generalized on the assumption that the block of the flat area is represented by (X₀, Y₀). Then, the shading component S (X, Y) at an arbitrary pixel in the block (X, Y) is given by the following Expression (11) using the horizontal direction shading component Sh (X, Y) calculated in the block (X, Y) and the normalized shading component Sv (X₀, Y) included in the same row.

S(X,Y)=Sh(X,Y)×Sv(X₀,Y) (11)

Alternatively, the shading component S (X, Y) at an arbitrary pixel in the block (X, Y) is given by the following Expression (12) using the vertical direction shading component Sv (X, Y) calculated in the block (X, Y) and the normalized shading component Sh (X, Y₀) included in the same column.

S(X,Y)=Sv(X,Y)×Sh(X,Y₀) (12)

By using Expression (11) or (12), the shading component calculation unit 203 calculates the shading components S (X, Y) in all the blocks where only the denormalized shading components have been calculated. The shading component calculation unit 203 then causes the storage unit 13 to store the shading components S (X, Y).

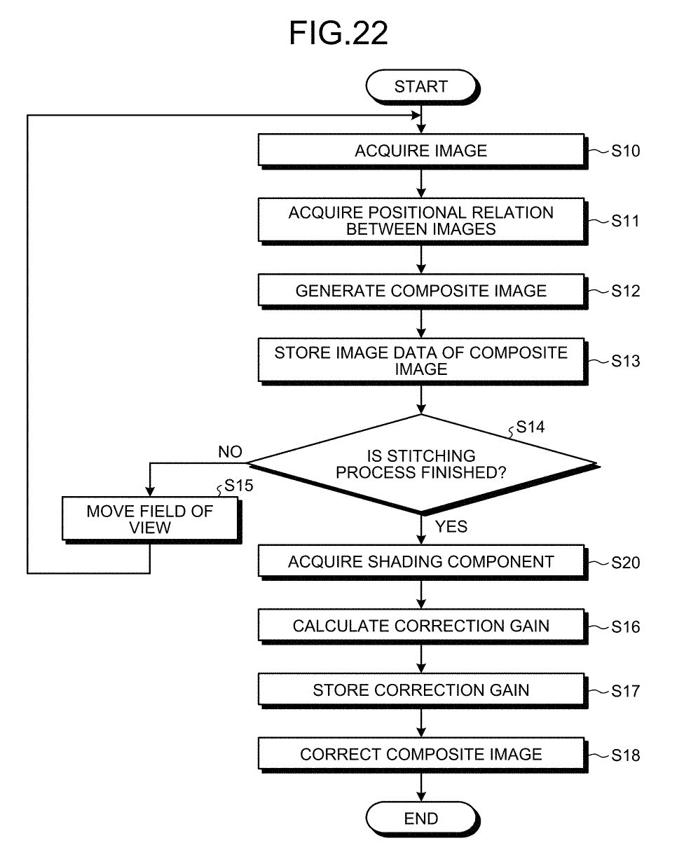

Next, the operation of the image processing apparatus according to the second embodiment will be described. FIG. 22 is a flowchart illustrating the operation of the image processing apparatus according to the second embodiment. In the flowchart, steps S10 to S15 are similar to those of the first embodiment. In step S15, however, the field of view V is moved so that at least one pair of images having sufficient common areas is acquired in each of the horizontal direction and the vertical direction of the image. More specifically, at least the central part of the image, namely, the flat area, is included in the common areas between the pair of images. The pair of images having the sufficient common areas is stored, not erased, after the pair of images is used for the generation of the composite image in step S12.

In step S14, when it is determined that the stitching process for the images is finished (step S14: Yes), the shading component acquisition unit 200 retrieves the pair of images having the sufficient common areas in each of the horizontal direction and the vertical direction, and acquires the shading component from the pair of images (step S20). Note that the common areas between the pair of images are positioned based on the positional relation between the images acquired in step S11. The method of acquiring the shading component is the same as that described with reference to FIGS. 15 to 21B. After the shading component is acquired, the pair of images may be erased.

Succeeding steps S16 to S18 are similar to those of the first embodiment. Among them, in step S16, the correction gain is calculated using the shading component acquired in step S20.

As described above, according to the second embodiment of the present invention, the shading component is acquired from the images acquired by the image acquisition unit 11. Therefore, a trouble of preparing a white plate for the acquisition of the shading component, replacing the object SP with the white plate, and capturing an image is not required, and the shading correction can be performed with a high degree of accuracy. In addition, the length Δw and the length Δh of a single block in the horizontal direction and the vertical direction of the image can be set in accordance with the distance by which the user freely moves the stage. Therefore, the present invention can be easily realized not only in a microscope system provided with an electric stage but also in a microscope system provided with a manual stage.

In the second embodiment, the process of acquiring the shading component is executed after the stitching process for the images is finished. However, the process of acquiring the shading component may be executed in parallel with the stitching process for the images as long as the pair of images that is used for the acquisition of the shading component has already been acquired.

In addition, in the second embodiment, the characteristics of the shading components in the horizontal direction and the vertical direction are obtained. However, the directions for obtaining the characteristics of the shading components are not limited to this example as long as the characteristics of the shading components in two different directions can be obtained.

### Modification

Next, a modification of the second embodiment of the present invention will be described.

In the second embodiment, the shading component S (X, Y) of the block (X, Y) where the normalized shading component has not been obtained is calculated using either Expression (11) or (12). Alternatively, the shading component S (X, Y) may be obtained by weighting and combining the shading components respectively given by Expressions (11) and (12).

As represented by Expression (11), the shading component provided by the horizontal direction shading component Sh (X, Y) that is the denormalized shading component of the block (X, Y) and the vertical direction shading component Sv (X₀, Y) that is the normalized shading component included in the same row as the block (X, Y) is regarded as a shading component Shy′ (X, Y) (Expression (13)).

Shv₁(X,Y)=Sh(X,Y)×Sv(X₀,Y) (13)

In addition, as represented by Expression (12), the shading component provided by the vertical direction shading component Sv (X, Y) that is the denormalized shading component of the same block (X, Y) and the horizontal direction shading component Sh (X, Y₀) that is the normalized shading component included in the same column as the block (X, Y) is regarded as a shading component Shv₂ (X, Y) (Expression (14)).

Shv₂(X,Y)=Sv(X,Y)×Sh(X,Y₀) (14)

A composite shading component S (X, Y) after weighting and combining the shading components Shy′ (X, Y) and Shv₂ (X, Y) is given by the following Expression (15).

S(X,Y)=(1−w(X,Y))×Shv₁(X,Y)+w(X,Y)×Shv₂(X,Y) (15)

In Expression (15), w (X, Y) is a weight that is used for the composition of the shading components. Since the shading component can generally be regarded as smooth, the weight w (X, Y) can be determined, for example, based on the ratio of the sums of edge amounts as represented by the following Expression (16).

$$w ( X , Y ) = β \times \frac{{Edge}_{h} [ Sh ( X , Y ) ] + {Edge}_{v} [ Sv ( {X}_{0} , Y ) ]}{{Edge}_{h} [ Sh ( X , {Y}_{0} ) ] + {Edge}_{v} [ Sv ( X , Y ) ]} \qquad ( 16 )$$

In Expression (16), the parameter β is a normalization coefficient. Edgeₕ [ ] represents the sum of the edge amounts in the horizontal direction in a target area (block (X, Y) or (X, Y₀)) of the distribution of the shading component in the horizontal direction. Edgeᵥ [ ] represents the sum of the edge amounts in the vertical direction in a target area (block (X₀, Y) or (X, Y)) of the distribution of the shading component in the vertical direction.

For example, when the sum of the edge amounts in the blocks (X, Y) and (X₀, Y) that are used for the calculation of the shading component Shv₁ (X, Y) is smaller than the sum of the edge amounts in the blocks (X, Y) and (X, Y₀) that are used for the calculation of the shading component Shv₂ (X, Y), the value of the weight w (X, Y) is reduced. Therefore, the contribution of the shading component Shv₁ to Expression (15) is increased.

As represented by Expression (16), the weight w (X, Y) is set based on the edge amount or contrast, whereby the two shading components Shy′ and Shv₂ can be combined based on the smoothness thereof. This enables the calculation of the composite shading component S that is much smoother and does not depend on the shift direction of the images used for the calculation of the shading component. Consequently, the shading correction can be robustly performed.

In the modification, the smooth composite shading component S (X, Y) is calculated by setting the weight w (X, Y) in accordance with Expression (16). Alternatively, a filtering process such as a median filter, an averaging filter, and a Gaussian filter may be used in combination to generate a far smoother composite shading component S (X, Y).

### Third Embodiment

Next, a third embodiment of the present invention will be described.

A configuration and operation of an image processing apparatus according to the third embodiment of the present invention are similar to those of the second embodiment as a whole, but a method of acquiring a shading component executed by the shading component acquisition unit 200 in step S20 (refer to FIG. 22) is different from that of the second embodiment. In the third embodiment, a shading component of the entire image is estimated based on shading components in common areas that overlap each other when two images are stitched together.

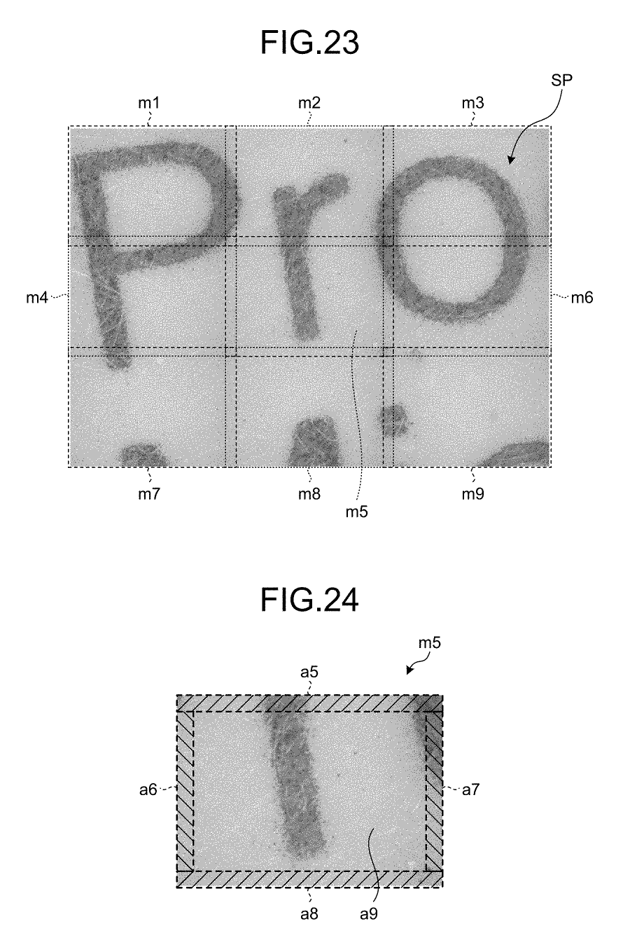

FIGS. 23 and 24 are schematic diagrams for explaining the method of acquiring the shading component in the third embodiment of the present invention. The following description is based on the assumption that, for example, the shading component is acquired from nine images acquired by capturing the object SP nine times as illustrated in FIG. 23. In the third embodiment as well, the images that are used for the acquisition of the shading component are stored, not erased, after the images are used for the generation of the composite image in step S12.

FIG. 24 is the image m5 located in the center of the nine images m1 to m9 illustrated in FIG. 23. The luminance of an arbitrary pixel included in an area a5 at the upper end of the image m5 is denoted by I (x, y). The luminance I (x, y) can be represented by the following Expression (17) using a texture component T (x, y) and a shading component S(x, y).

I(x,y)=T(x,y)×S(x,y) (17)

The area a5 is a common area equivalent to an area at the lower end of the image m2. The luminance of a pixel at coordinates (x′, y′) in the image m2 corresponding to the coordinates (x, y) in the image m5 is denoted by I′ (x′, y′). The luminance I′ (x′, y′) can also be represented by the following Expression (18) using a texture component T′ (x′, y′) and a shading component S (x′, y′).

I′(x′,y′)=T′(x′,y′)×S(x′,y′) (18)

As mentioned above, the texture components T (x, y) and T′ (x′, y′) are equal to each other since the area a5 at the upper end of the image m5 is the common area equivalent to the area at the lower end of the image m2. Therefore, the following Expression (19) is satisfied in accordance with Expressions (17) and (18).

$$\frac{I ( x , y )}{{I}^{′} ( {x}^{′} , {y}^{′} )} = \frac{S ( x , y )}{S ( {x}^{′} , {y}^{′} )} \qquad ( 19 )$$

In other words, the ratio of the luminance in the common areas between the two images corresponds to the ratio of the shading components.

The image m5 is obtained by shifting the field of view V on the xy plane with respect to the image m2, and the shift amount is provided by the positional relation between the images acquired in step S11. If the shift amount is denoted by Δx and Δy, Expression (19) can be transformed into the following Expression (20).

$$\frac{I ( x , y )}{{I}^{′} ( {x}^{′} , {y}^{′} )} = \frac{S ( x , y )}{S ( x - Δ x , y - Δ y )} \qquad ( 20 )$$

In other words, the ratio I (x, y)/I′ (x′, y′) of the luminance is equivalent to the variation in the shading component that depends on the position in the image. Note that Δx=0 is satisfied between the images m5 and m2.

Similarly, in an area a6 at the left end, an area a7 at the right end, and an area a8 at the lower end of the image m5, the variations of the shading components can be calculated using the luminance in the common areas shared between the adjacent images m4, m6, and m8.

Next, a shading model that approximates the shading component S (x, y) in the image is produced, and the shading model is modified using the ratio of the luminance calculated in each of the areas a5, a6, a7, and a8. An example of the shading model includes a quadric that is minimal at the center coordinates of the image.

Specifically, a model function f (x, y) representing the shading model (for example, quadratic function representing the quadric) is produced, and the model function f (x, y) is evaluated by an evaluation function K given by the following Expression (21).

$$K = {\sum }_{( x , y )} {\{ \frac{I ( x , y )}{{I}^{′} ( {x}^{′} , {y}^{′} )} - \frac{f ( x , y )}{f ( x - Δ x , y - Δ y )} \}}^{2} \qquad ( 21 )$$

More specifically, the evaluation function K is calculated by assigning, to Expression (21), the ratio I (x, y)/I′ (x′, y′) of the luminance at the coordinates (x, y) in the areas a5 to a8 and a value of the model function f (x, y) at the coordinates (x, y), and the model function f (x, y) corresponding to the minimum evaluation function K is obtained. Then, the shading component S (x, y) at the coordinates (x, y) in the image is calculated simply by use of the model function f (x, y). For the method of acquiring the shading component by modifying the shading model based on the evaluation function K, refer to JP 2013-132027 A as well.

In addition, various well-known techniques can be applied as the method of acquiring the shading component from the images acquired by the image acquisition unit 11. For example, a technique similar to that of JP 2013-257411 A can be employed. More specifically, the luminance of a pixel in a central area of one image (namely, flat area of the shading component) is assumed to be I (x, y)=T (x, y)×S (x, y), and the luminance of a pixel in an area within the other image, that is, a common area equivalent to the central area, is assumed to be I′ (x′, y′)=T′ (x′, y′)×S (x′, y′). Considering that the texture components T (x, y) and T′ (x′, y′) are equivalent to each other, the shading component S (x′, y′) in the area (x′, y′) is given by the following Expression (22).

S(x′,y′)=I′(x′,y′)/I(x,y)×S(x,y) (22)

Since the central area (x, y) of the image is the flat area, the shading component S (x′, y′) in the area (x′, y′) is given by the following Expression (23) if the shading component S (x, y)=1 is satisfied.

S(x′,y′)=I′(x′,y′)/I(x,y) (23)

### Fourth Embodiment

Next, a fourth embodiment of the present invention will be described.

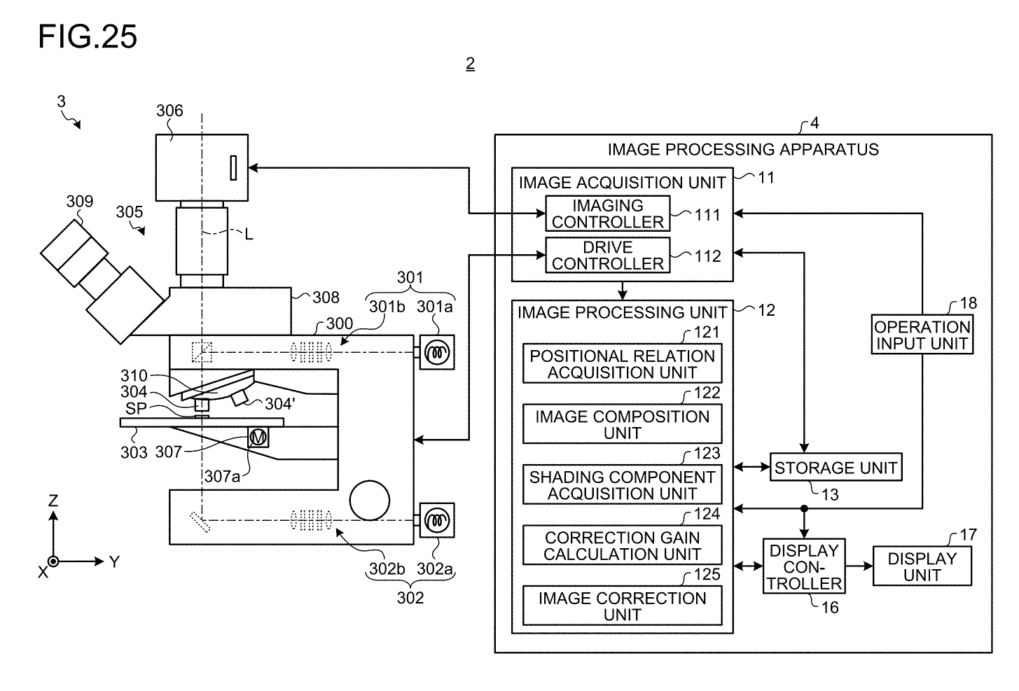

FIG. 25 is a schematic diagram illustrating an exemplary configuration of a microscope system according to the fourth embodiment of the present invention. As illustrated in FIG. 25, a microscope system 2 according to the fourth embodiment includes a microscope device 3 and an image processing apparatus 4 that processes an image acquired by the microscope device 3 and displays the image.

The microscope device 3 has a substantially C-shaped arm 300, a specimen stage 303, an objective lens 304, an imaging unit 306, and a stage position change unit 307. The arm 300 is provided with an epi-illumination unit 301 and a transmitted-light illumination unit 302. The specimen stage 303 is attached to the arm 300, and the object SP to be observed is placed on the specimen stage 303. The objective lens 304 is provided at one end side of a lens barrel 305 via a trinocular lens barrel unit 308 so as to face the specimen stage 303. The imaging unit 306 is provided at the other end side of the lens barrel 305. The stage position change unit 307 moves the specimen stage 303. The trinocular lens barrel unit 308 causes observation light of the object SP that has come in through the objective lens 304 to branch off and reach the imaging unit 306 and an eyepiece unit 309 to be described later. The eyepiece unit 309 enables a user to directly observe the object SP.

The epi-illumination unit 301 includes an epi-illumination light source 301a and an epi-illumination optical system 301b, and irradiates the object SP with epi-illumination light. The epi-illumination optical system 301b includes various optical members (a filter unit, a shutter, a field stop, and an aperture stop or the like) that collect illumination light emitted from the epi-illumination light source 301a and guide the illumination light in a direction of an observation light path L.

The transmitted-light illumination unit 302 includes a transmitted-light illumination light source 302a and a transmitted-light illumination optical system 302b, and irradiates the object SP with transmitted-light illumination light. The transmitted-light illumination optical system 302b includes various optical members (a filter unit, a shutter, a field stop, and an aperture stop or the like) that collect illumination light emitted from the transmitted-light illumination light source 302a and guide the illumination light in a direction of the observation light path L.

The objective lens 304 is attached to a revolver 310 capable of holding a plurality of objective lenses (for example, objective lenses 304 and 304′) having different magnifications. This revolver 310 is rotated to change the objective lens 304, 304′ that faces the specimen stage 303, whereby the imaging magnification can be varied.

A zoom unit including a plurality of zoom lenses (not illustrated) and a drive unit (not illustrated) that varies positions of the zoom lenses is provided inside the lens barrel 305. The zoom unit adjusts the positions of the respective zoom lenses, whereby an object image within the field of view is magnified or reduced. The drive unit in the lens barrel 305 may further be provided with an encoder. In this case, an output value of the encoder may be output to the image processing apparatus 4, and the positions of the zoom lenses may be detected in the image processing apparatus 4 in accordance with the output value of the encoder, whereby the imaging magnification may be automatically calculated.

The imaging unit 306 is a camera including an imaging sensor, e.g., a CCD and a CMOS, and capable of capturing a color image having a pixel level (luminance) in each of bands R (red), G (green), and B (blue) in each pixel provided in the imaging sensor. The imaging unit 306 operates at a predetermined timing in accordance with the control of the imaging controller 111 of the image processing apparatus 4. The imaging unit 306 receives light (observation light) that has come in through the optical system in the lens barrel 305 from the objective lens 304, generates image data corresponding to the observation light, and outputs the image data to the image processing apparatus 4. Alternatively, the imaging unit 306 may convert the luminance represented by the RGB color space into the luminance represented by the YCbCr color space, and output the luminance to the image processing apparatus 4.

The stage position change unit 307 includes, for example, a ball screw (not illustrated) and a stepping motor 307a, and moves the position of the specimen stage 303 on the XY plane to vary the field of view. The stage position change unit 307 also moves the specimen stage 303 along the Z axis, whereby the objective lens 304 is focused on the object SP. The configuration of the stage position change unit 307 is not limited to the above-mentioned configuration, and, for example, an ultrasound motor or the like may be used.

In the fourth embodiment, the specimen stage 303 is moved while the position of the optical system including the objective lens 304 is fixed, whereby the field of view for the object SP is varied. Alternatively, the field of view may be varied in such a manner that a movement mechanism that moves the objective lens 304 on a plane orthogonal to an optical axis is provided, and the objective lens 304 is moved while the specimen stage 303 is fixed. Still alternatively, both the specimen stage 303 and the objective lens 304 may be moved relatively to each other.

In the image processing apparatus 4, the drive controller 112 controls the position of the specimen stage 303 by indicating drive coordinates of the specimen stage 303 at a pitch defined in advance based on, for example, a value of a scale mounted on the specimen stage 303. Alternatively, the drive controller 112 may control the position of the specimen stage 303 based on a result of image matching such as template matching that is based on the images acquired by the microscope device 3.

The image processing apparatus 4 includes the image acquisition unit 11, the image processing unit 12, the storage unit 13, a display controller 16, a display unit 17, and an operation input unit 18. Among them, a configuration and operation of each of the image acquisition unit 11, the image processing unit 12, and the storage unit 13 are similar to those of the first embodiment. In place of the shading component acquisition unit 123, the shading component acquisition unit 200 described in the second and third embodiments may be applied.

The display controller 16 produces a screen including the composite image generated by the image processing unit 12, and displays the screen on the display unit 17.

The display unit 17 includes, for example, an LCD, an EL display or the like, and displays the composite image generated by the image processing unit 12 and associated information in a predetermined format in accordance with a signal output from the display controller 16.

The operation input unit 18 is a touch panel input device incorporated in the display unit 17. A signal that depends on a touch operation performed from outside is input to the image acquisition unit 11, the image processing unit 12, and the display controller 16 through the operation input unit 18.

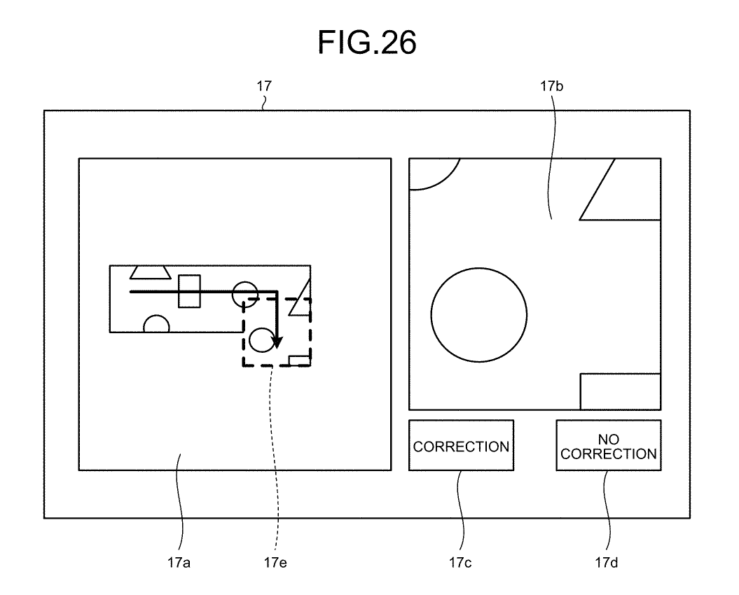

FIG. 26 is a schematic diagram illustrating an exemplary screen displayed on the display unit 17. This screen includes a macro display area 17a, a micro display area 17b, and correction selecting buttons 17c and 17d. A magnified image of the object SP is displayed in the macro display area 17a. A further magnified image of an area selected in the macro display area 17a is displayed in the micro display area 17b. In the screen, the function of the operation input unit 18 is activated in the macro display area 17a and the correction selecting buttons 17c and 17d. Hereinafter, the operation of the microscope system 2 in response to the touch on the screen will be described.

Prior to the observation of the object SP, the user places the object SP on the specimen stage 303 of the microscope device 3, and touches a desired position on the macro display area 17a using a finger, a touch pen or the like.

The operation input unit 18 inputs positional information representing the touched position to the image acquisition unit 11 and the display controller 16 in response to the touch operation for the macro display area 17a. The user may slide the finger or the touch pen while the macro display area 17a is touched. In this case, the operation input unit 18 sequentially inputs the serially varying positional information to each unit.

The image acquisition unit 11 calculates the position on the specimen stage 303 corresponding to the positional information input from the operation input unit 18, and performs the drive control on the specimen stage 303 so that the position is located in the center of the field of view. Then, the image acquisition unit 11 causes the imaging unit 306 to execute the capturing, thereby acquiring the image.

The image processing unit 12 retrieves the image from the image acquisition unit 11, and executes the stitching process for the retrieved image and the image acquired before, the calculation of the correction gain that is applied to the composite image, and the shading correction.

The display controller 16 displays a frame 17e having a predetermined size on the macro display area 17a based on the positional information input from the operation input unit 18. The center of the frame 17e is located at the touched position. Then, the display controller 16 displays, within the frame 17e, the composite image after the shading correction, generated by the image processing unit 12. When the positional information is varied in response to the touch operation by the user, the display controller 16 sequentially moves the frame 17e in accordance with the positional information. In this case, the display unit 17 maintains the composite image displayed on the macro display area 17a as it is, and sequentially updates and displays the composite image only in the area within the frame 17e. An arrow illustrated in the macro display area 17a of FIG. 26 indicates a track of the touch by the user on the macro display area 17a.

The display controller 16 further magnifies a part of the composite image included in the frame 17e, and displays the part of the composite image in the micro display area 17b.

In response to the touch operation on the correction selecting button (“no correction”) 17d, the operation input unit 18 outputs, to the image processing unit 12, a signal indicating output of the composite image before the shading correction. Accordingly, the image processing unit 12 reverts the generated composite image after the shading correction to the composite image before the shading correction using the reciprocal of the correction gain (namely, shading component) calculated by the correction gain calculation unit 124. The image processing unit 12 then outputs the reverted composite image. The image processing unit 12 also outputs a new composite image generated thereafter in state of the composite image before the shading correction. The display controller 16 displays the composite image before the shading correction output from the image processing unit 12 on the display unit 17.

In response to the touch operation on the correction selecting button (“correction”) 17c, the operation input unit 18 outputs, to the image processing unit 12, a signal indicating output of the composite image after the shading correction. Accordingly, the image processing unit 12 performs the shading correction again on the generated composite image before the shading correction using the correction gain calculated by the correction gain calculation unit 124. The image processing unit 12 then outputs the composite image. The image processing unit 12 also outputs a new composite image generated thereafter in state of the composite image after the shading correction. The display controller 16 displays the composite image after the shading correction output from the image processing unit 12 on the display unit 17.

As described above, according to the fourth embodiment of the present invention, the user only needs to touch the macro display area 17a to observe the composite image (virtual slide image) in which a desired area of the object SP is shown. During the observation, the user can operate the correction selecting buttons 17c and 17d to appropriately switch between the composite image before the shading correction and the composite image after the shading correction.

In the fourth embodiment, although the method of acquiring the shading component in each image is not particularly limited, the method described in the second embodiment is relatively suitable. This is because the pair of images having the sufficient common areas can be successively obtained since the field of view is serially varied in the fourth embodiment.

In the fourth embodiment, switching between the composite image before the shading correction and the composite image after the shading correction is performed on the display unit 17. Alternatively, these composite images may be simultaneously displayed adjacent to each other on the display unit 17.

According to some embodiments, a composite image is generated by stitching a plurality of images of different fields of view based on a positional relation between the images, a correction gain that is used for a shading correction for the composite image is calculated based on the positional relation, and the shading correction is performed on the composite image using the correction gain. Therefore, the time required for the shading correction for the individual images can be saved, and the throughput of the stitching process can be improved. In addition, according to the present invention, the shading correction can be freely performed as compared with the conventional shading correction in such a manner, for example, that the shading correction alone is performed again after the composite image is generated. Furthermore, according to some embodiments, the correction gain that is used for the shading correction for the composite image is produced. Therefore, the composite image before the shading correction and the composite image after the shading correction can be appropriately generated without the use of the individual images before the shading correction. Therefore, the individual images before the shading correction no longer need to be stored, and the memory capacity can be saved.

The present invention is not limited to the first to fourth embodiments and the modification. A plurality of elements disclosed in the first to fourth embodiments and the modification can be appropriately combined to form various inventions. For example, some elements may be excluded from all the elements described in the first to fourth embodiments and the modification to form the invention. Alternatively, elements described in the different embodiments may be appropriately combined to form the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an image acquisition unit configured to acquire a plurality of images of different fields of view, each of the plurality of images having a common area to share a common object with at least one other image of the plurality of images;
a positional relation acquisition unit configured to acquire a positional relation between the plurality of images;
an image composition unit configured to stitch the plurality of images based on the positional relation to generate a composite image;
a shading component acquisition unit configured to acquire a shading component in each of the plurality of images;
a correction gain calculation unit configured to calculate a correction gain that is used for a shading correction of the composite image, based on the shading component and the positional relation; and
an image correction unit configured to perform the shading correction on the composite image using the correction gain.

2. The image processing apparatus according to claim 1, wherein
the image composition unit is configured to weight and add luminance in the common area between adjacent images of the plurality of images using a blending coefficient to calculate luminance in an area in the composite image corresponding to the common area, and
the correction gain calculation unit is configured to calculate the correction gain that is applied to the area in the composite image using the blending coefficient.

3. The image processing apparatus according to claim 1, further comprising:
a display unit configured to display the composite image; and
an operation input unit configured to input a command signal in accordance with an operation performed from outside, wherein
the display unit is configured to switch between the composite image after the shading correction and the composite image before the shading correction, in accordance with the command signal.

4. The image processing apparatus according to claim 1, wherein
the shading component acquisition unit is configured to calculate the shading component from at least two images sharing the common area among the plurality of images.

5. The image processing apparatus according to claim 4, wherein
the shading component acquisition unit comprises:
a first shading component calculation unit configured to calculate characteristics of the shading component in a first direction using luminance of the common area between a first pair of images of the plurality of images in the first direction;
a second shading component calculation unit configured to calculate characteristics of the shading component in a second direction different from the first direction using luminance of the common area between a second pair of images of the plurality of images in the second direction; and
a third shading component calculation unit configured to calculate the shading component in each of the plurality of images using the characteristics of the shading component in the first direction and the characteristics of the shading component in the second direction.

6. The image processing apparatus according to claim 4, wherein
the shading component acquisition unit is configured to:
calculate a ratio of luminance in the common area between the at least two images; and
estimate the shading component in each of the plurality of images using the ratio of the luminance.

7. The image processing apparatus according to claim 1, wherein
the shading component acquisition unit is configured to calculate the shading component using luminance in a central area of a first image of the plurality of images and luminance in the common area of a second image of the plurality of images corresponding to the central area.

8. An imaging apparatus comprising:
the image processing apparatus according to claim 1; and
an imaging unit configured to image the object and output an image signal.

9. A microscope system comprising:
the image processing apparatus according to claim 1;
an imaging unit configured to image the object and output an image signal;
a stage on which the object is configured to be placed; and
a drive unit configured to move at least one of the imaging unit and the stage relative to the other.

10. An image processing method, comprising:
acquiring a plurality of images of different fields of view, each of the plurality of images having a common area to share a common object with at least one other image of the plurality of images;
acquiring a positional relation between the plurality of images;
stitching the plurality of images based on the positional relation to generate a composite image;
acquiring a shading component in each of the plurality of images;
calculating a correction gain that is used for a shading correction of the composite image, based on the shading component and the positional relation; and
performing the shading correction on the composite image using the correction gain.

11. A non-transitory computer-readable recording medium with an executable image processing program stored thereon, the image processing program causing a computer to execute:
acquiring a plurality of images of different fields of view, each of the plurality of images having a common area to share a common object with at least one other image of the plurality of images;
acquiring a positional relation between the plurality of images;
stitching the plurality of images based on the positional relation to generate a composite image;
acquiring a shading component in each of the plurality of images;
calculating a correction gain that is used for a shading correction of the composite image, based on the shading component and the positional relation; and
performing the shading correction on the composite image using the correction gain.
